(19) United States
(12) Patent Application Publication
(10) Pub. No.: US 2001/0051842 A1
(43) Pub. Date: Dec. 13, 2001

(54) Apparatus and method for producing an indexed three-dimensional landmark on compact discs for subsequent use or processing

(75) Inventor: Serles G. Cameron, Oakville (CA)

Correspondence Address: HOFBAUER ASSOCIATES, 205 N 1455 LAKESHORE ROAD, BURLINGTON, ON, L7S SJ1, CA

(73) Assignee: Duplium Corporation, Thornhill, ON (CA)

(21) Appl. No.: 09/875,854

(22) Filed: Jun. 8, 2001

Related U.S. Application Data
(60) Provisional application No. 60/211,111, filed on Jun. 12, 2000.

(51) Int. Cl. B29C 39/00

(52) U.S. Cl. 700/197

(57) ABSTRACT

An apparatus for producing a three-dimensional landmark on compact discs comprises a disc orienting station for orienting compact discs each having a reference marker, so as to form marked compact discs. The disc orienting station automatically determines the angular orientation, with respect to an angular reference frame, of the reference marker on a marked compact disc, and automatically rotates the marked compact disc disposed at the disc orienting station about a central axis of the compact disc such that the reference marker is disposed at a pre-determined angular orientation with respect to the angular reference frame. A landmark forming station forms the three-dimensional landmark on the marked compact disc in a location having a known angular displacement about the central axis with respect to the reference marker. The compact discs are transported in seriatim from the disc orienting station in the predetermined angular orientation to the landmark forming station.

### FIELD OF THE INVENTION

The present invention relates to the manufacture of optically readable compact discs. More particularly, the present invention relates to an apparatus and method for producing an indexed three-dimensional landmark on compact discs, such as optically readable compact discs in CD, CD-ROM, and DVD formats, and the like, to facilitate their subsequent use and processing, such as, for example, subsequent cutting of such compact discs into non-standard shapes in a CNC router machine.

### BACKGROUND OF THE INVENTION

It is becoming well known for optical disc manufacturers of optically readable compact discs, to offer custom-shaped (i.e., non-circular) optically readable compact discs for play in CD, CD-ROM, and DVD formats. In the prior art, each optically readable disc starts as a conventional round disc, with data (ie., music, computer programs, etc.) already encoded in the proper optically readable format on one side of the disc and with a human readable graphical pattern printed on the other side of the disc. The graphical pattern typically includes information identifying the information stored on the disc. To cut the disc to a final non-standard shape, the circular disc is placed into a CNC router, and the starting point for cutting by the router is aligned manually through use of visual sighting of a chosen reference point on the compact disc's printed graphical pattern by the CNC machine operator, such that the optical disc may be cut into the desired custom shape by the CNC router machine. Absent such initial manual alignment by the operator, the outside edge pattern cut by the CNC router typically would not register with the printed graphical pattern on the disc, which is commercially unacceptable. To date, this method of manually aligning each optical disc at the beginning of the final cutting process (by the CNC router machine) has been utilized to accommodate the virtually unlimited variety of printed graphical patterns and corresponding custom shapes. However, since this method requires that optically readable discs be aligned one-at-a-time under human supervision, it is slow and not cost effective, with the consequent high cost being passed on to the end consumer. Additionally, this method of aligning optically readable discs prior to cutting them into custom shapes introduces a significant possibility of imprecise cutting which might result from human error.

One known prior art patent that deals with the cutting of an irregular shaped compact disc is U.S. Pat. No. 5,942,165 issued Aug. 24, 1999 (Sabatini), which patent is entitled Method For Making Irregular Shaped CD's And Other Playing Discs. That patent teaches a method of making irregular shaped playing discs to achieve a proper balance for playing, and involves the use of a grid divided into quadrants having squares of a predetermined size. A template is placed on the grid into which desired artwork is fitted such that an equal number of squares is taken from each quadrant. In this manner, proper balance for playing the compact disc will be realized. Once the shape of the area available for the artwork is determined, the artwork and the recording medium can be applied. There is no means for rotationally indexing the compact disc during the manufacturing process.

It is an object of the present invention to provide an apparatus method for rotationally indexing compact discs during the manufacturing process.

It is another object of the present invention to provide an apparatus and method for producing a three-dimensional landmark on compact discs for subsequent use or processing of the compact discs relative to the three-dimensional landmark.

It is yet another object of the present invention to provide an apparatus invented for producing a three-dimensional landmark on compact discs for subsequent cutting of the compact discs, relative to the three-dimensional landmark, into non-standard shaped compact discs.

It is still another object of the present invention to provide an apparatus invented for producing a three-dimensional landmark on compact discs for subsequent cutting of the compact discs, relative to the three-dimensional landmark, into non-standard shaped compact discs, that is significantly more efficient than manual rotational alignment of compact discs through use of visual sighting by a machine operator.

It is yet another object of the present invention to provide an apparatus and method for manufacturing non-standard shaped compact discs that will reduce the cost associated with such manufacturer and which will more fully standardize and automate such manufacture.

### SUMMARY OF THE INVENTION

In accordance with one aspect of the present invention there is disclosed an apparatus for producing a three-dimensional landmark on compact discs for subsequent use or processing of the compact discs relative to the three-dimensional landmark. The apparatus comprises a disc orienting station for orienting compact discs each having at least one reference marker thereon, so as to form marked compact discs. The disc orienting station includes means for automatically determining the angular orientation, with respect to an angular reference frame, of the at least one reference marker on a marked compact disc disposed at the disc orienting station, and means for automatically rotating the marked compact disc disposed at the disc orienting station about a central axis of the compact disc such that the at least one reference marker is disposed at a pre-determined angular orientation with respect to the angular reference frame. A landmark forming station includes means for forming the three-dimensional landmark on the marked compact disc disposed at the landmark forming station, in a location having a known angular displacement about the central axis of the compact disc with respect to the at least one reference marker. A disc transport means comprises means for transporting the compact discs in seriatim from the disc orienting station in the predetermined angular orientation to the landmark forming station.

In accordance with another aspect of the present invention there is disclosed an apparatus for producing a three-dimensional landmark on compact discs for subsequent cutting of the compact discs, relative to the three-dimensional landmark, into non-standard shaped compact discs. The apparatus comprises a disc orienting station for orienting compact discs having at least one reference marker thereon, so as to form marked compact discs. The disc orienting station includes means for automatically determining the angular orientation, with respect to an angular reference frame, of the at least one reference marker on the marked compact disc disposed at the disc orienting station, and means for automatically rotating the marked compact disc disposed at the disc orienting station about a central axis of the compact disc such that the at least one reference marker is disposed at a pre-determined angular orientation with respect to the angular reference frame. A landmark forming station includes means for forming the three-dimensional landmark on the marked compact disc disposed at the landmark forming station, in a location having a known angular displacement about the central axis of the compact disc with respect to the at least one reference marker. A disc transport means comprises means for transporting the compact discs in seriatim from the disc orienting station to the landmark forming station.

In accordance with yet another aspect of the present invention there is disclosed a method of producing a three-dimensional landmark on a plurality of compact discs for subsequent use or processing of the compact discs relative to the three-dimensional landmark, the method comprising the steps of:

(A) introducing at least one reference marker onto each of the compact discs at a first predetermined location, to thereby produce marked compact discs;

(B) automatically determining the angular orientation with respect to an angular reference frame of the at least one reference marker on each marked compact disc;

(C) automatically rotating each marked compact disc about a central axis of the compact disc such that the at least one reference marker is disposed at a pre-determined angular orientation with respect to an angular reference frame;

(D) forming the three-dimensional landmark on each marked compact disc in a location having a known angular displacement about the central axis of the compact disc with respect to the at least one reference marker.

In accordance with still another aspect of the present invention there is disclosed a method of producing a three-dimensional landmark on plurality of compact discs for subsequent cutting of the compact discs relative to the three-dimensional landmark, into non-standard shaped compact discs, the method comprising the steps of:

(A) introducing at least one reference marker onto each of the compact discs at a first predetermined location, to thereby produce marked compact discs;

(B) automatically determining the angular orientation with respect to an angular reference frame of the at least one reference marker on each marked compact disc;

(C) automatically rotating each marked compact disc about a central axis of the compact discs such that the at least one reference marker is disposed at a pre-determined angular orientation with respect to an angular reference frame;

(D) forming the three-dimensional landmark on each marked compact disc in a location having a known angular displacement about the central axis of the compact disc with respect to the at least one reference marker.

### BRIEF DESCRIPTION OF THE DRAWINGS

The novel features which are believed to be characteristic of the and method for producing a three-dimensional landmark on compact discs for subsequent use or processing apparatus according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. Hereinafter, all references to the term “compact disc” shall be interpreted as a reference to all forms of optically readable compact discs, including, without limitation, compact discs having any one of the CD, CD-ROM, and DVD formats, and the like. In the accompanying drawings:

FIG. 1 is a perspective view from the right front of a preferred embodiment of an apparatus for producing a three-dimensional landmark on compact discs according to the present invention, with compact discs in place in both the loading station and the unloading station;

FIG. 2 is a perspective view similar to FIG. 1, with an upper frame of the apparatus removed for the sake of clarity;

FIG. 3 is an enlarged perspective view of a portion of FIG. 2;

FIG. 4 is a view similar to FIG. 3 with the pick and place arm of FIG. 7 removed for ease of illustration;

FIG. 5 is a front elevational view of the embodiment of FIG. 2;

FIG. 6 is a top plan view of the apparatus of FIG. 2, but with the compact discs removed from the disc orienting station and the landmark forming station for ease of illustration;

FIG. 7 is a top plan view of the pick and place arm used in the preferred embodiment of FIG. 2;

FIG. 8 is an enlarged sectional side elevational view of the vacuum pickup head used on the pick and place arm of FIG. 7, taken along section line 8-8 of FIG. 7;

FIG. 9 is a sectional side elevational view of the disc orienting station of the apparatus of FIG. 2, taken along section line 9-9 of FIG. 6;

FIG. 10A is a greatly enlarged side elevational view of a portion of FIG. 9, showing a compact disc being put into place on the disc orienting station;

FIG. 10B is a greatly enlarged side elevational view similar to FIG. 10A, with the compact disc clamped in place;

FIG. 10C is a greatly enlarged side elevational view similar to FIG. 10B, showing an unclamped compact disc being removed from the disc orienting station;

FIG. 10D is an extremely enlarged side elevational view of a portion of FIG. 10B;

FIG. 10E is an extremely enlarged side elevational view of a portion of FIG. 10C;

FIG. 11 is an enlarged top plan view of the disc orienting station of the apparatus of FIG. 2;

FIG. 12 is an enlarged perspective view from the right front of the landmark forming station of the apparatus of FIG. 2;

FIG. 13 is a view similar to FIG. 12 but with a compact disc in place on the landmark forming station;

FIG. 14 is a top plan view of a portion of FIG. 6, but with compact discs in place at all four stations;

FIG. 15 is a top plan view similar to FIG. 14, with the pick and place arm having rotated clockwise by ninety degrees, thereby moving compact discs from one station to the next;

FIG. 16 is a top plan view similar to FIG. 15, with the pick and place arm having rotated counter-clockwise by ninety degrees back to the rotational position shown in FIG. 14;

FIG. 17 is an enlarged sectional side elevational view of an alternative embodiment vacuum pickup head used on the pick and place arm;

FIG. 18A is a top plan view of a conventional compact disc before the addition of graphics and reference marks according to the present invention;

FIG. 18B is a top plan view of the compact disc of FIG. 15A, in place in a holder;

FIG. 18C is a top plan view similar to FIG. 15B, but with graphics having been added; and,

FIG. 18D is a top plan view similar to FIG. 15B, but with reference marks having been added according to the present invention.

### DETAILED DESCRIPTION OF A PREFERRED EMBODIMENT

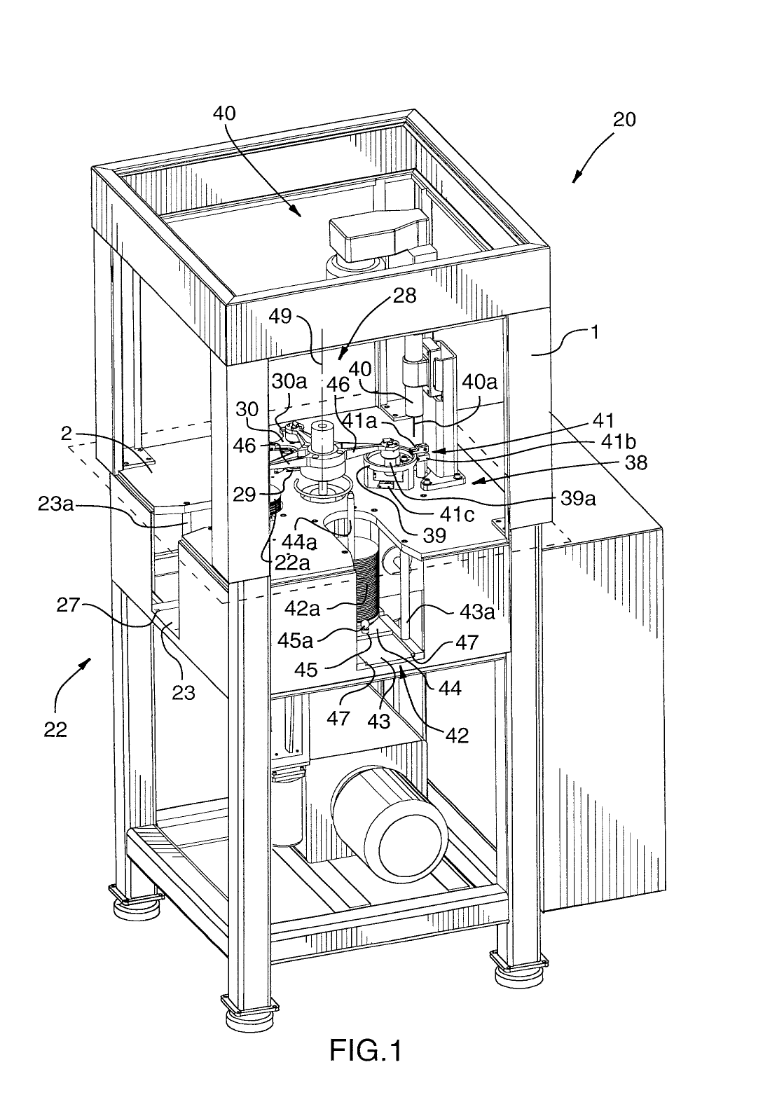

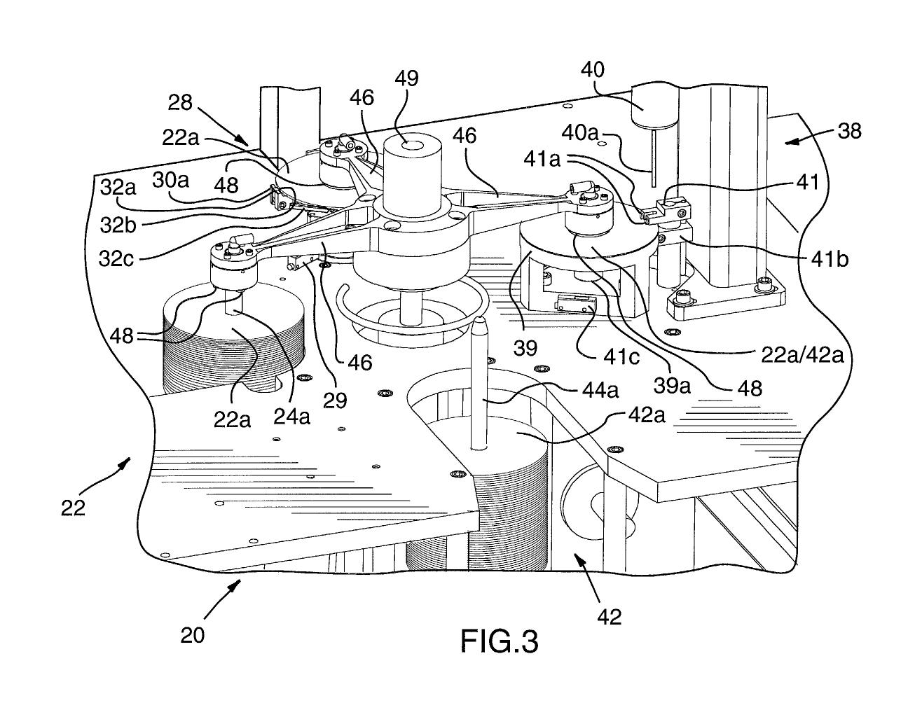

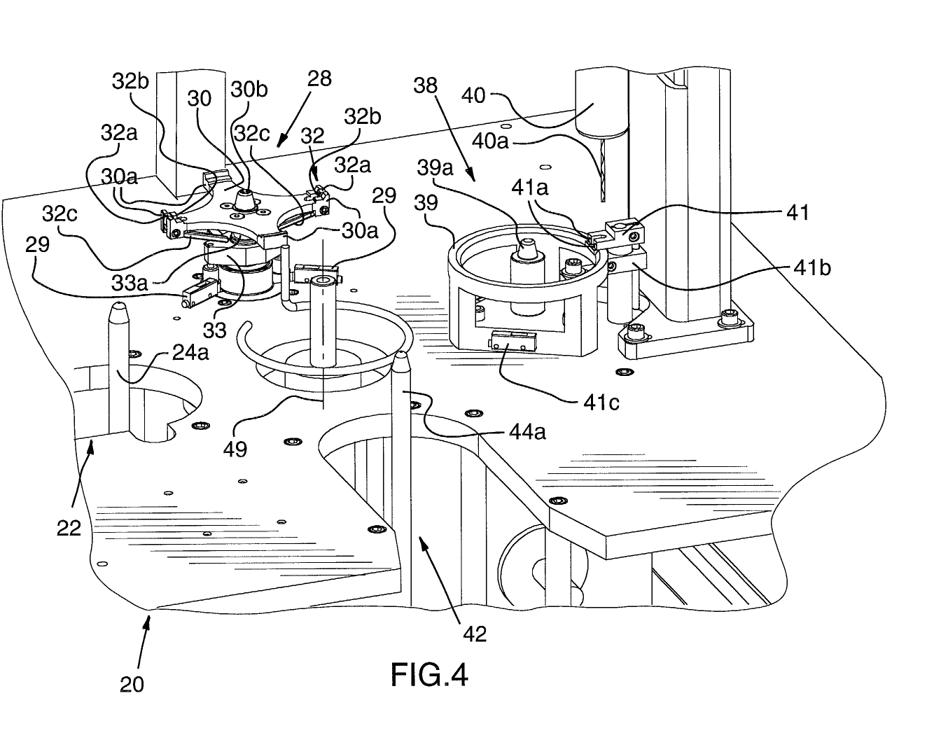

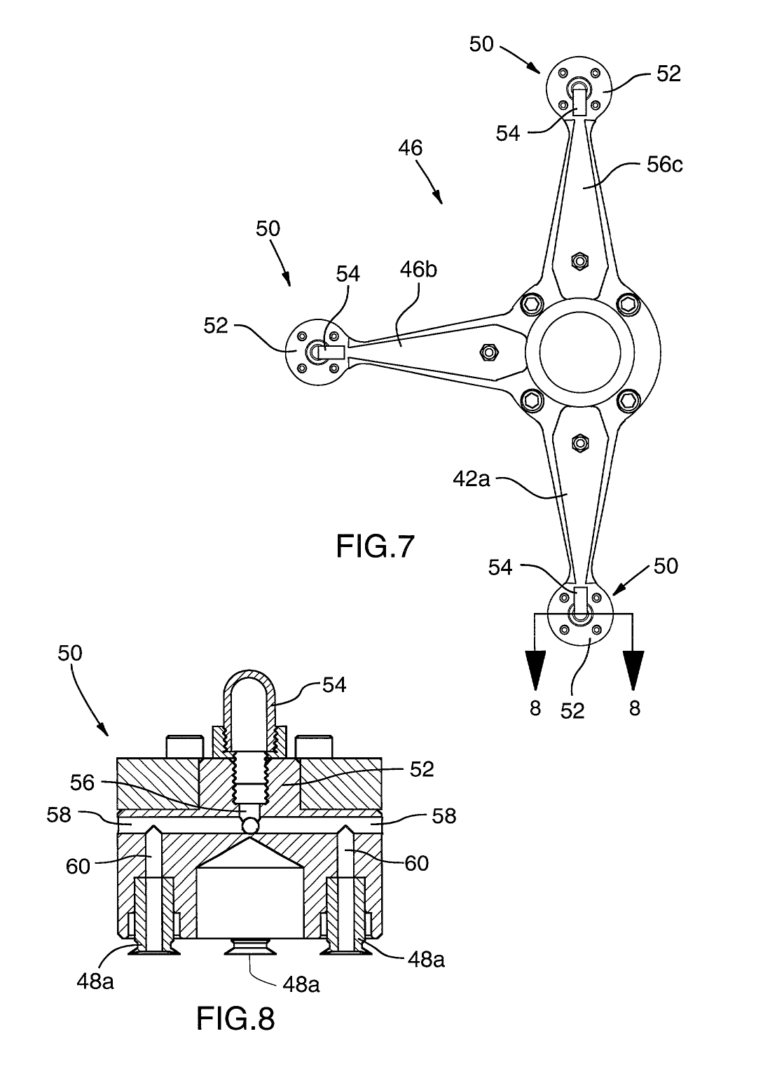

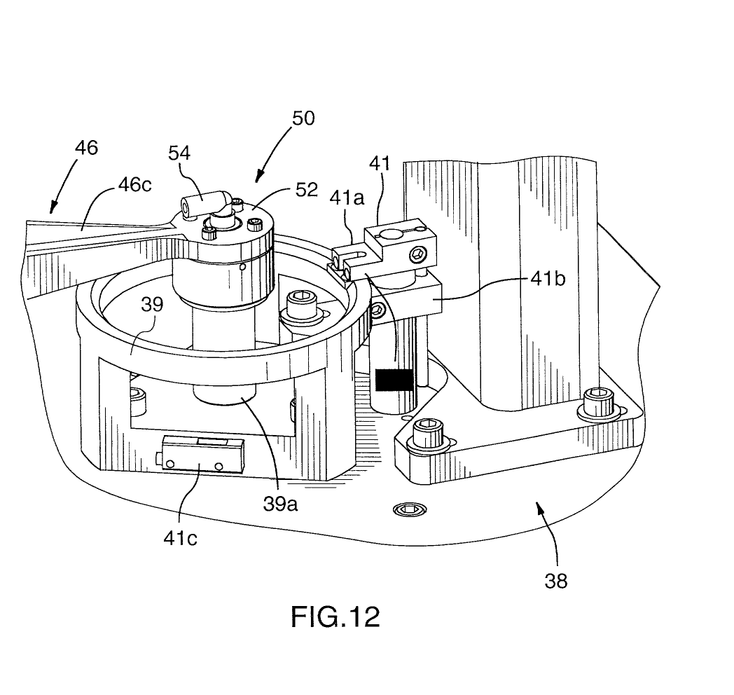

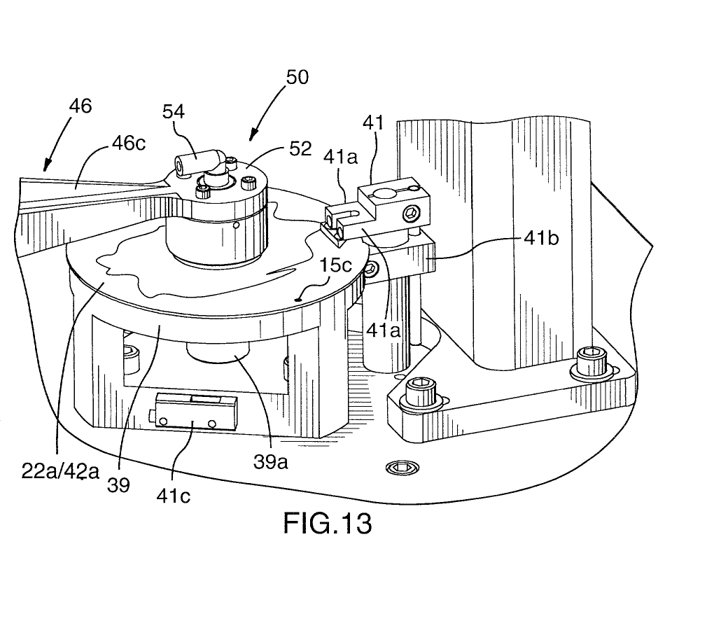

A preferred form of an apparatus according to the present invention is shown in its preferred embodiment in FIGS. 1 through 12, as designated by the general reference numeral 20. The apparatus 20 is for producing three-dimensional landmarks on compact discs for subsequent use or processing, such as cutting of the compact discs, relative to the three-dimensional landmark, into non-standard shaped compact discs, or orienting compact discs in a pre-determined angular orientation in a compact disc package or cover. Such compact discs typically include CD's, CD-ROMs, DVD's, and the like. The present invention also includes a method for producing three-dimensional landmarks on compact discs for subsequent use or processing, such as cutting of the compact discs, relative to the three-dimensional landmark, into non-standard shaped compact discs, or orienting compact discs in a pre-determined angular orientation in a compact disc package or a cover. The apparatus 20 comprises a removable upper frame 1 as can be best seen in FIG. 1, and a main table 2 frame supported by legs 3. There are four distinct stations situated around the main table 2, namely a disc loading station, designated by the general reference numeral 22, a disc orienting station designated by the general reference numeral 28, a landmark forming station designated by the general reference numeral 38, and a disc unloading station designated by the general reference numeral 42 circumferentially arranged with respect to each other. A disc transport means comprising a pick and place arm assembly 46, is used to pick up a marked compact disc 22a from the disc loading station 22, and move the marked compact disc 22a from one station to the next station (in a rotary motion about vertical axis 49) until it becomes a finished compact disc 42a at the disc unloading station 42, as will be discussed in greater detail below.

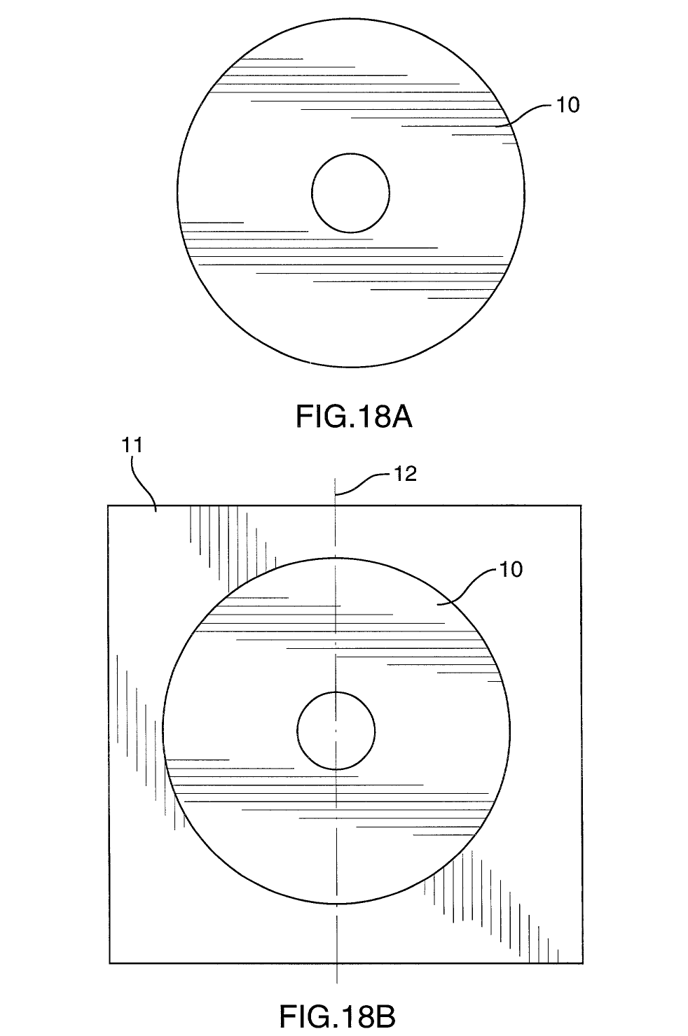

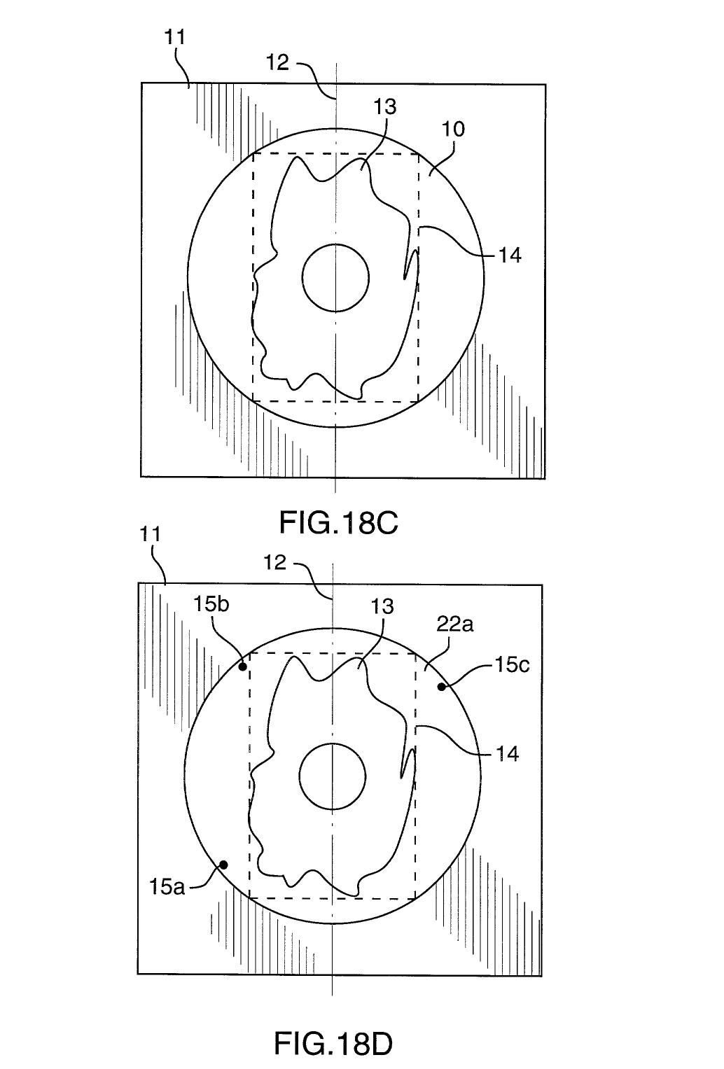

It should be first understood that each marked compact disc 22a is produced from a conventional blank compact disc 10, as best seen in FIG. 18A, by adding one or more reference markers. In the preferred embodiment illustrated, three reference markers are used, a first reference marker 15a, a second reference marker 15b, and a third reference marker 15c, marked on the top side, as best seen in FIG. 18D. As few as one reference marker could, however, be used. The three reference markers are preferably printed near the perimeter edge of the compact disc and are preferably placed outside a graphical pattern 13 that is typically also printed on the top side (unreadable side) of the compact disc. The first reference marker 15a is introduced onto a compact disc 10 at a first predetermined location, the second reference marker 15b is introduced onto a compact disc at a second predetermined location, and the third reference marker 15c is introduced onto a compact disc 10 at a third predetermined location, to thereby produce a marked compact disc 22a. Typically, but not necessarily, the first 15a, second 15b, and third 15c reference markers are printed onto compact discs 10 simultaneously with the printing of the graphical pattern 13, but could be printed thereon after the graphical pattern 13 has already been printed thereon. Alternatively, the graphical pattern 13 could be printed on marked compact discs 22a.

Where the graphical pattern 13 is not printed on the conventional compact disc 10 as part of the original printed image, it is necessary to index the graphical pattern 13 to the reference markers 15a, 15b and 15c by a separate step or means, if it is desired to cut the compact disc 10 in an indexed manner to said graphical pattern 13. In this case a blank compact disc 10 is placed in a suitable receiving base 11 having a reference axis 12 (FIG. 18B). The graphics 13 are printed on the compact disc 10 so as to be in a known angular orientation with respect to a reference axis 12. The intended final outline of the compact disc is indicated by reference numeral 14. The first reference marker 15a, the second reference marker 15b, and the third reference marker 15c are then printed on the compact disc 10 (FIG. 18D) so as to be in a known angular orientation with respect to the reference axis 12, and are therefore in proper angular orientation with respect to the graphics 13 and the outline 14 of the shape of the cut compact disc 10. Such indexed printing of the reference markers produce a marked compact disc 22a. In the preferred embodiment illustrated, the first 15a and second 15b reference markers are angularly spaced ninety degrees apart, have a diameter of 5 millimeters, and are at a radial distance of 56.5 millimeters from the center of the compact disc 10.

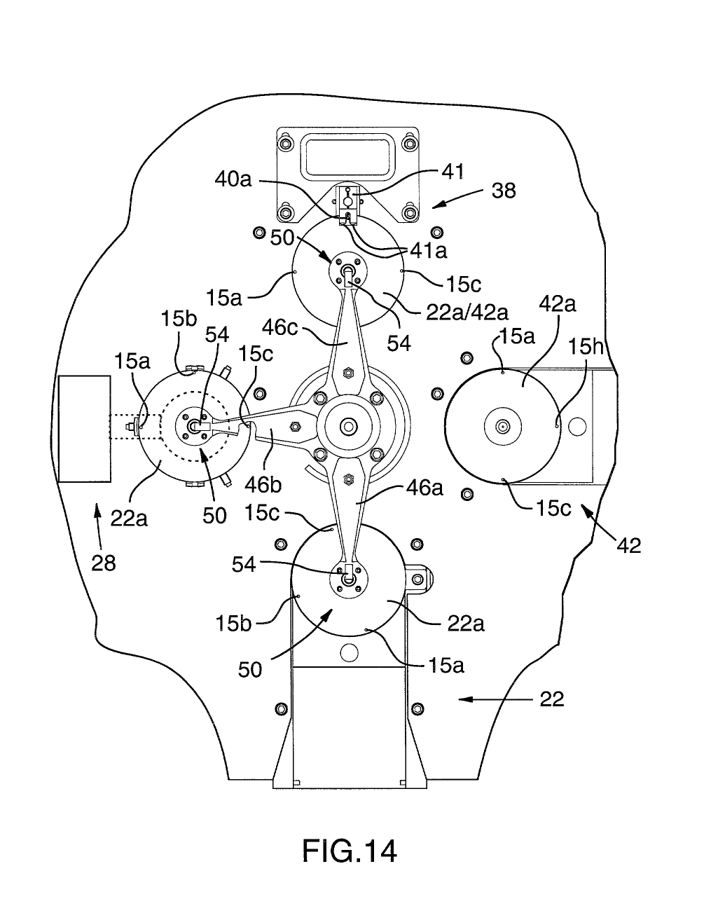

As will be discussed in greater detail subsequently, a small CNC reference hole 15h (see FIGS. 14 through 16) will be drilled through each marked compact disc 22a in fixed relation to the three reference markers 15a, 15b, and 15c, preferably at the second reference mark 15b, thus providing an accurate physical reference to the graphical pattern 13 for the CNC router machine that may subsequently be used to cut the round marked compact disc 22a to its final outline 14.

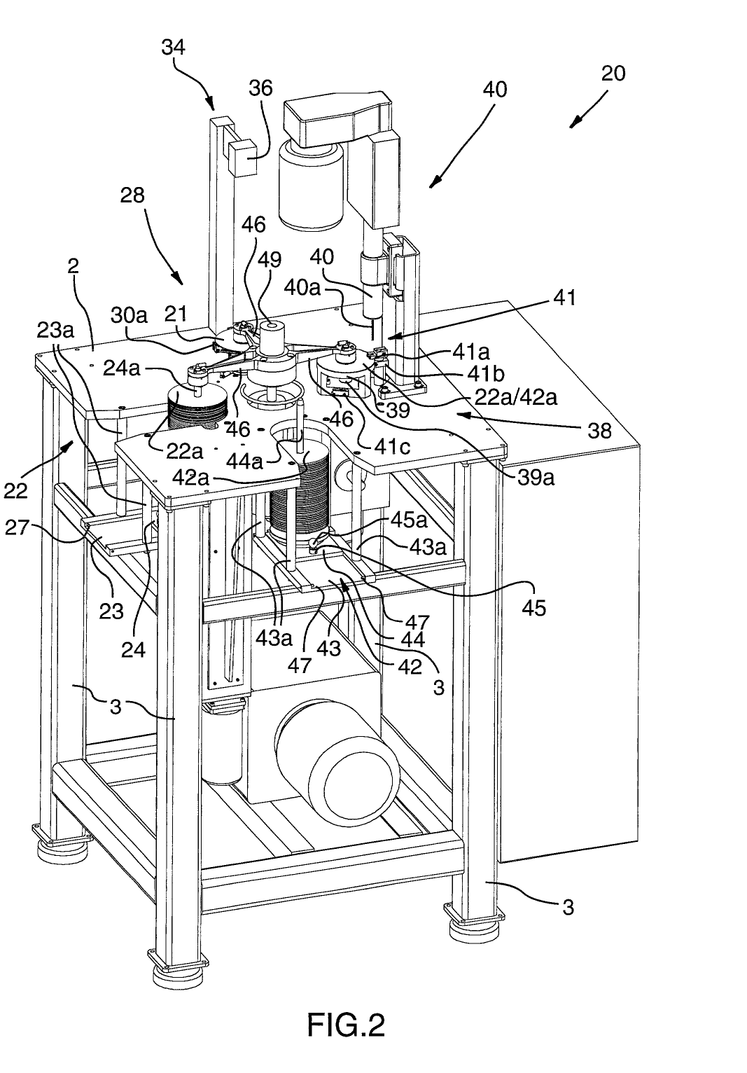

Turning to FIGS. 1 and 2, it will be seen that the disc loading station 22 of the apparatus 20 comprises a spindle support base 23 mounted to the main table 2 by depending legs 23a. A sliding loading tray 24 is retained on the spindle support base 23 in removable and replaceable relation. A lock member 25 engages a co-operating bore hole in the spindle support base 23, which lock member 25 is manually operable by means of a handle member 25a. A spindle 24a projects upwardly from the sliding loading tray 24 through a platten 25c and a spacer 25b, as can be best seen in FIGS. 21 and 22. A plurality of marked compact discs 22a are received around the spindle 24a in supported relation on the spacer 25b. The sliding loading tray 24, the platten 25c, the spacer 25b, and the spindle 25b together form a compact disc carrier assembly of the type that is used to load marked compact discs 22a into the disc loading station 22, and subsequently unload compact discs from the disc unloading station 42. Two stop members 27 are securely mounted on the spindle support base 23 to preclude the sliding loading tray 24 from being inadvertently slid off the outer end of the spindle support base 23.

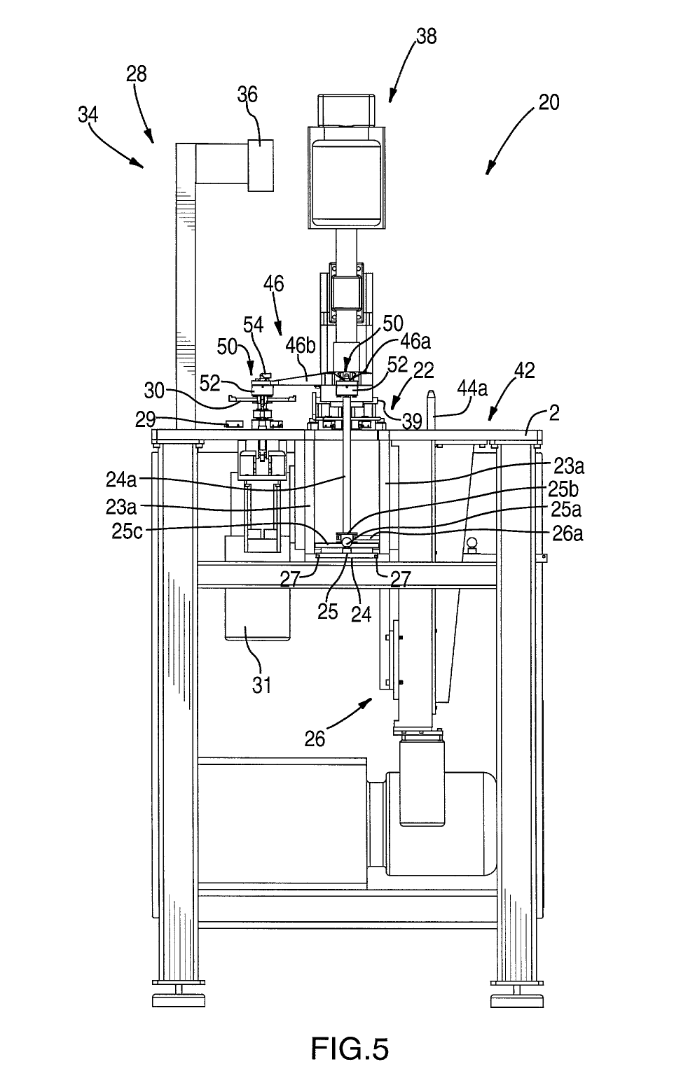

A stack lifter mechanism 26, as is best seen in FIG. 5, has a lifter arm 26a that engages the spindle 24a so as to permit lifting of the marked compact discs 22a while in place in the disc loading station 22, such that the top one of the marked compact discs 22a is positioned at a predetermined height for subsequent pickup, as will be discussed in greater detail subsequently.

The disc transport means, which in the preferred embodiment is the pick and place arm assembly 46, comprises means for transporting marked compact discs 22a in seriatim from the disc loading station 22 to the disc orienting station 28, means for transporting marked compact discs 22a in seriatim from the disc orienting station 28 in their predetermined angular orientation to the landmark forming station 38, and means for transporting the marked compact discs 22a in seriatim from the landmark forming station 38 to the disc unloading station 42 in their predetermined angular orientation. In the preferred embodiment illustrated, the means for transporting marked compact discs 22a in seriatim from the disc loading station 22 to the disc orienting station 28 comprises the first arm portion 46a of the pick and place arm assembly 46; the means for transporting marked compact discs 22a in seriatim from the disc orienting station 28 in their predetermined angular orientation to the landmark forming station 38 comprises the second arm portion 46b of the pick and place arm assembly 46; and the means for transporting the marked compact discs 22a in seriatim from the landmark forming station 38 to the disc unloading station 42 in their predetermined angular orientation comprises the third arm portion 46c of the pick and place arm assembly 46.

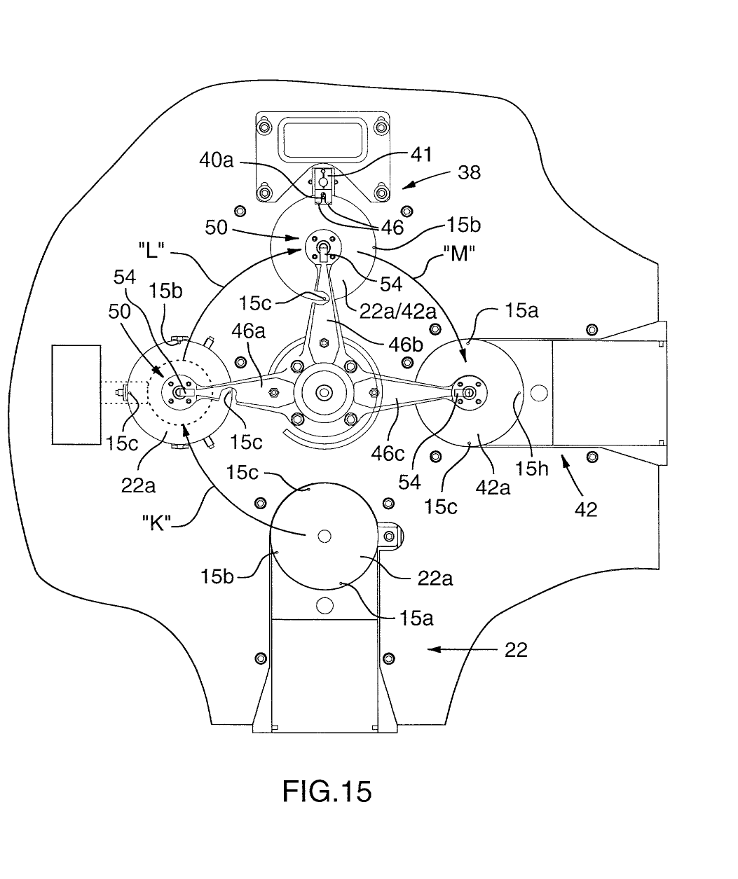

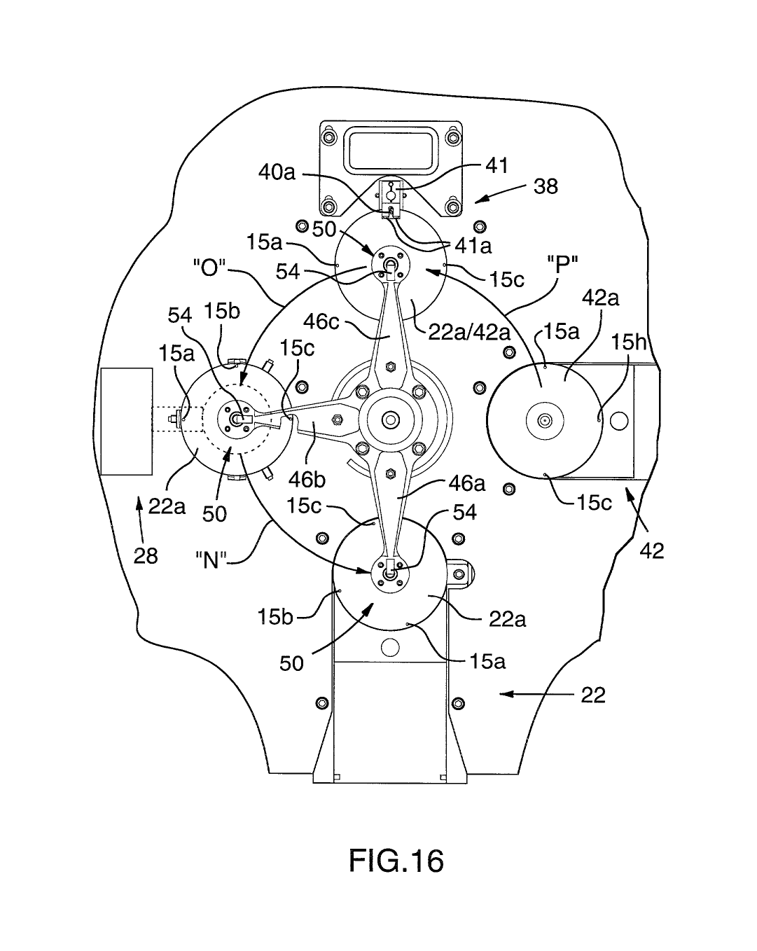

The pick and place arm assembly 46 is operatively mounted on the apparatus 20 centrally between the disc loading station 22, the disc orienting station 28, the landmark forming station 38, and the disc unloading station 42, in spaced relation above the main table 2 for rotary motion about the vertical axis 49, and comprises a first arm portion 46a, a second arm portion 46b, and a third arm portion 46c. Starting in the position shown in FIG. 14, the first arm portion 46a picks up marked compact discs 22a one at a time, in seriatim, from the disc loading station 22 and delivers them one by one to the disc orienting station 28, as indicated by arrow “K” in FIG. 15; the second arm portion 46b picks up compact discs from the disc orienting station 28 and delivers them to the landmark forming station 38, as indicated by arrow “L” in FIG. 15; and the third arm portion 46c picks up compact discs from the landmark forming station 38 and delivers them to the disc unloading station 42, as indicated by arrow “M” in FIG. 15. The pick and place arm assembly 46 then reverses direction as indicated by arrows “N”, “O”, and “P” in FIG. 16, until it arrives at its original position, as seen in FIG. 14.

As can be best seen in FIG. 16, each of the first 46a, second 46b, and third 46c arm portions has a vacuum pickup head 50 mounted at its outer end for picking up and subsequently releasing the marked compact discs 22a and the finished compact discs 42a. Each vacuum pickup head 50 comprises a main body portion 52 and a vacuum fitting 54 mounted on the top of the main body portion 52. The vacuum fitting 54 is in fluid communication with a source of vacuum, or at least low air pressure, through a suitable vacuum hose (not shown), and is also in fluid communication with a main vertical passageway 56 in the main body portion 52. The main vertical passageway 56 is in fluid communication with a plurality of horizontal passageways 58, with each of horizontal passageways 58 being in fluid communication with respective secondary vertical passageway 60. The secondary vertical passageways 60 lead to suction cups 48 mounted in downwardly facing relation with respect to the main body portion 52. The main vertical passageway 56, the plurality of horizontal passageways 58, and the secondary vertical passageways 60 together essentially form a manifold. The vacuum pickup head 50 on the first arm portion 46a (as shown in FIG. 8) has a plurality of suction cups 48a. The vacuum pickup head 50 on each of the second arm portion 46b and the third arm portion 46a has a single suction cup 48a.

The disc orienting station 28 is for orienting marked compact discs 22a each having at least one reference marker thereon, and in the preferred embodiment illustrated having, as previously discussed in more detail, the first reference marker 15a, the second reference marker 15b and the third reference marker 15c thereon.

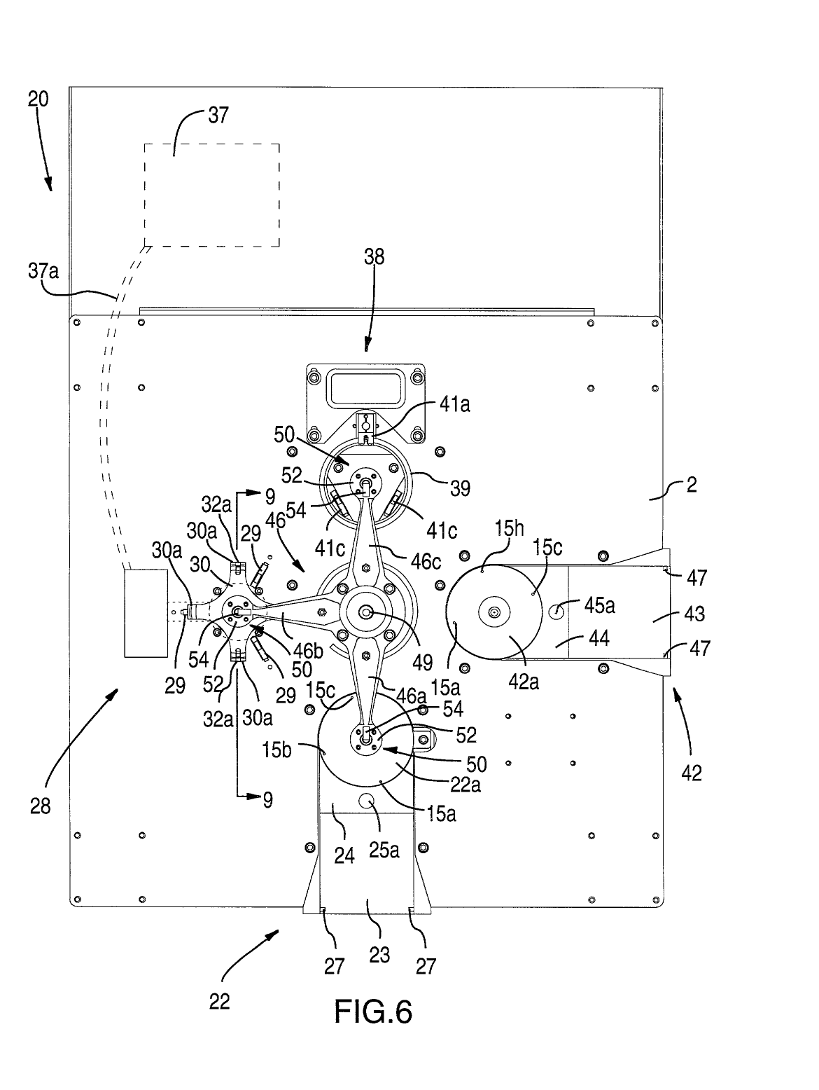

The disc orienting station 28 includes means 34 for automatically determining the angular orientation, with respect to an angular reference frame, of the first reference marker 15a, the second reference marker 15b and the third reference marker 15c on the marked compact disc 22a disposed at the disc orienting station 28. The angular reference frame preferably comprises a two-dimensional angular co-ordinate system expressed as polar co-ordinates with respect to a central axis. The co-ordinates of any given point are expressed in terms of a radius from the central axis (expressed in linear units such as inches or centimeters), with the radius being directed in a plane oriented perpendicularly to the central axis, and an angle of rotation with respect to a pre-determined zero degree axis extending radially outwardly from the central axis (expressed in angular units such as degrees or radians). The angular reference frame is represented mathematically within software executed by the vision computer 37 in conjunction with the digital camera 36 such that the central axis and the predetermined zero degree axis are fixed in the field of vision of the digital camera 36. The markers 15a, 15b, and 15c are represented within the vision computer 37 and the digital camera 36 as angular co-ordinates with respect to the central axis and the pre-determined zero degree axis. The angular reference frame must have its central axis co-incident with the central axis 22b of each marked compact disc 22a in place on the rotating orientation platter 30 of the landmark forming station 38. The pre-determined zero degree axis can be conveniently chosen to be oriented at any angle around the central axis. The means 34 for automatically determining angular orientation comprises a digital camera 36, mounted over the disc orienting station 28, and a vision computer 37, operatively connected to the disc orienting station 28 and the digital camera 36 via a communications cable 37a, as is best seen in FIG. 6.

The disc orienting station 28 also includes means for automatically rotating the marked compact disc 22a disposed at the disc orienting station 28 about a central axis 22b of the marked compact disc 22a such that one of the first reference marker 15a, the second reference marker 15b and the third reference marker 15c is disposed at a pre-determined angular orientation with respect to the angular reference frame. The means for automatically rotating the marked compact disc 22a comprises a rotatable orientation platter 30 powered by an electric servo motor 31, which rotating orientation platter 30 receives the marked compact discs 22a thereon as placed by the pick and place arm assembly 46, and as guided by four peripheral guides 30a and a central spindle 30b on the rotating orientation platter 30. The presence of an round marked compact disc 22a on the rotating orientation platter 30 is sensed by three proximity sensors 29. The proximity sensors 29 are preferably optical sensors that transmit light onto a marked compact disc 22a in place on the rotating orientation platter 30, and detect reflected light from the marked compact disc 22a, thereby permitting determination of whether the marked compact disc 22a is seated properly in place on the rotating orientation platter 30.

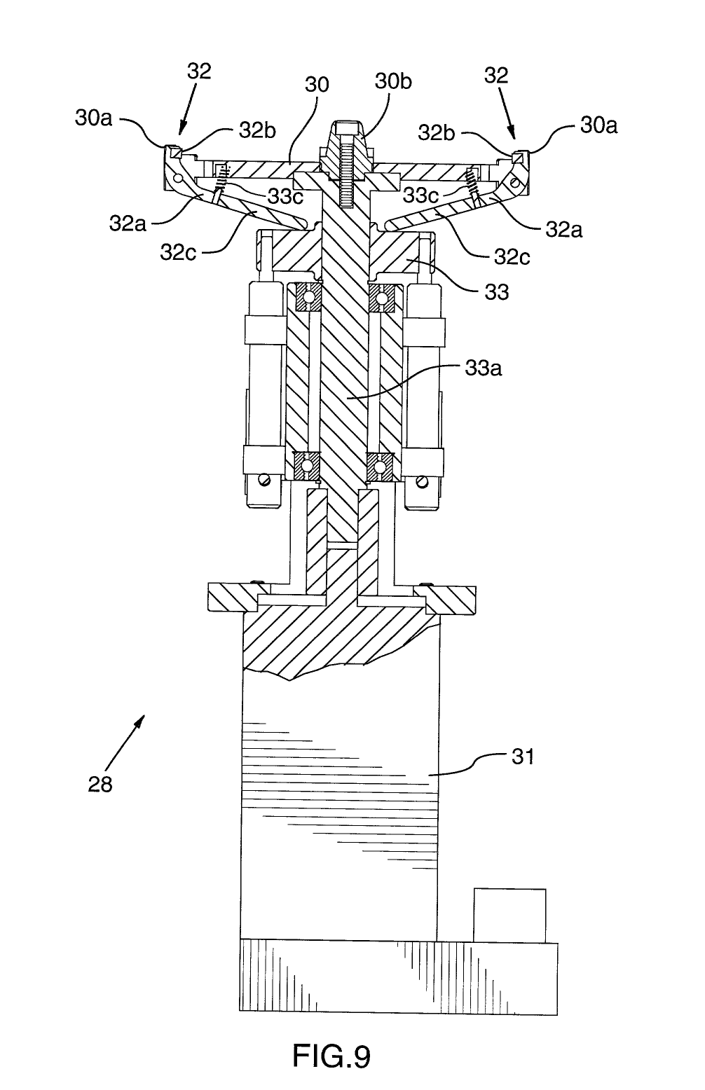

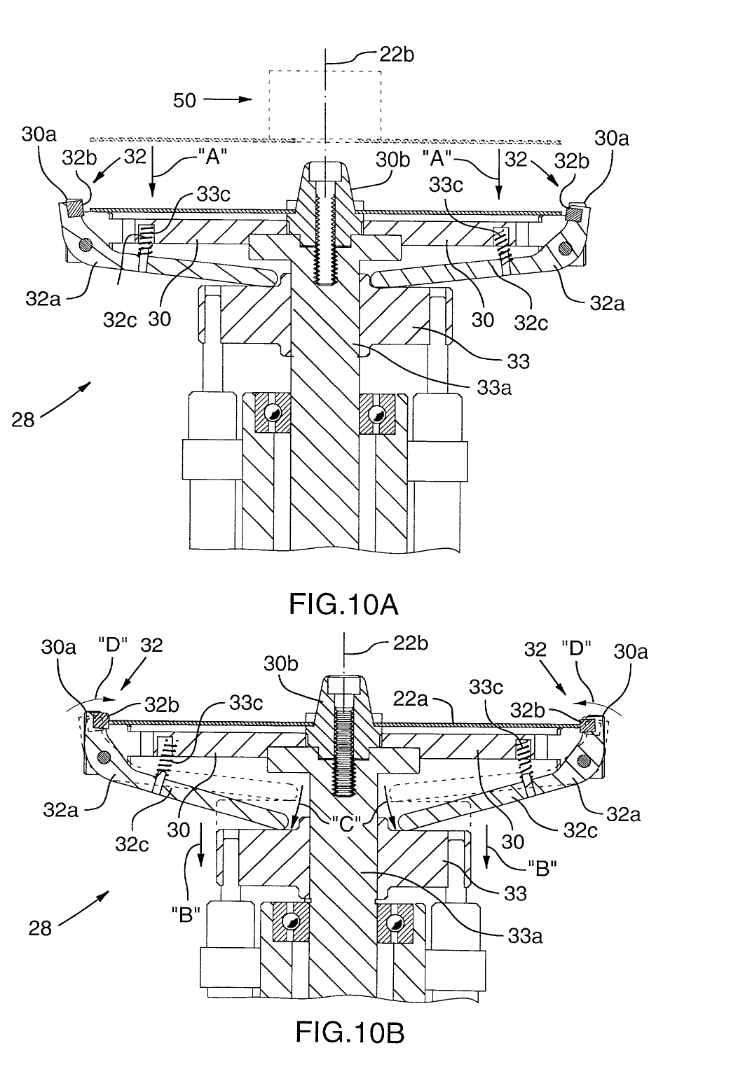

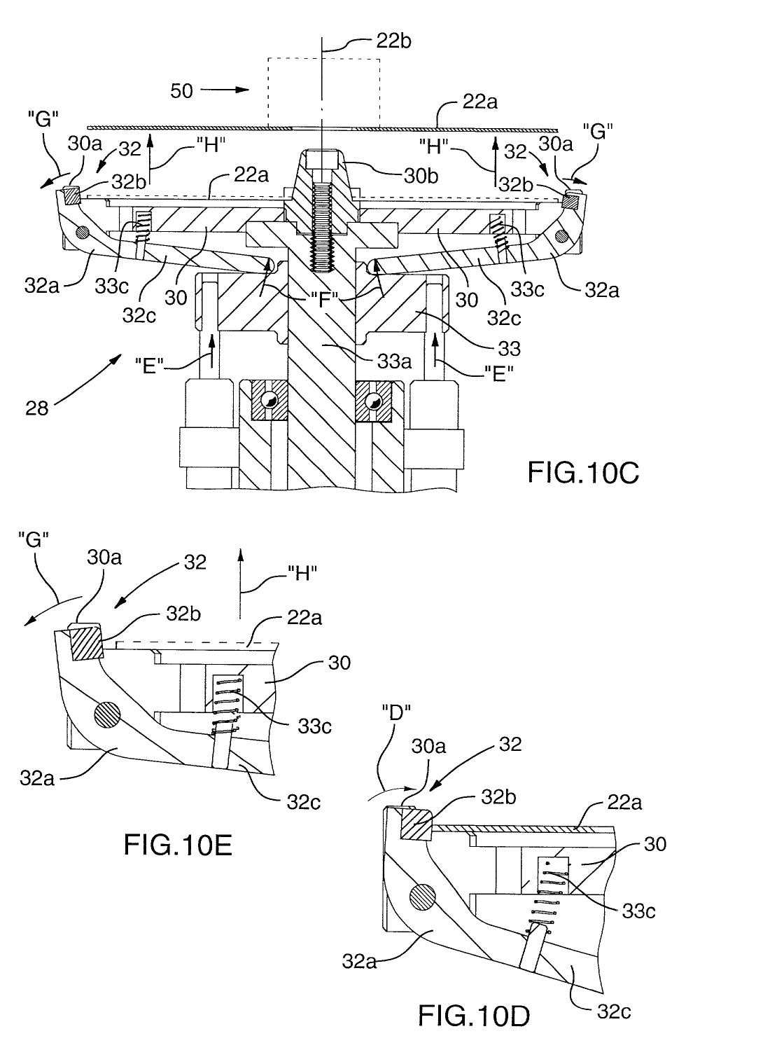

A clamping mechanism, as designated by the general reference numeral 32 and as best seen in FIGS. 9 through 10E, is used to clamp the marked compact discs 22a in place on the rotating orientation platter 30, and includes two pivotally mounted fingers 32a mounted on two opposed ones of the four peripheral guides 30a. Each pivotally mounted finger 32a has a clamping portion 32b that is made from a slightly pliable plastic material, such as polypropylene, to preclude damage to the marked compact discs 22a, and also has an elongate lower portion 32c that operatively contacts a collar member 33 that is mounted in vertically sliding relation on a spindle 33a, as powered by hydraulic cylinders 33b. Vertical movement of the collar member 33 along the spindle 33a operates the clamping mechanism 32, as will be discussed in greater detail subsequently.

The landmark forming station 38 of the present invention includes means for forming the three-dimensional landmark on the marked compact disc 22a disposed at the landmark forming station 38. The three-dimensional landmark is formed in a location having a known angular displacement about the central axis 22b of the marked compact disc 22a with respect to one of the first reference marker 15a, the second reference marker 15b and the third reference marker 15c.

In the preferred embodiment illustrated, the means for forming a three-dimensional landmark comprises a drill mechanism 40 having a drill bit 40a for drilling a small CNC drill hole 15h (the three-dimensional landmark ) through each of the marked compact disc s 22a, as best seen in FIGS. 14 through 16, in a location having a known angular displacement about the central axis 22b of the marked compact disc 22a, with respect to each of the first 15a, second 15b, and third 15c reference markers, thus producing finished compact discs 42a. Each marked compact disc 22a is placed on a support ring 39, and is clamped in place by a clamping mechanism 41 having a bifurcated clamping drill guide 41a, that moves vertically with respect to the base 41b of the clamping mechanism 41. In this manner, the position of each marked compact disc 22a remains unchanged during drilling. The drill bit 40a passes between the two finger portions of the bifurcated clamping drill guide 41a. The presence of a marked compact disc 22a on the support ring 39 is sensed by two proximity sensors 41c. The proximity sensors 41c are preferably optical sensors that transmit light onto the marked compact disc 22a in place on the support ring 39, and detect reflected light from the marked compact disc 22a, thereby permitting determination of whether the marked compact disc 22a is seated properly in place on the support ring 39.

As can best be seen in FIGS. 14 through 16, the marked compact disc 22a on the disc orienting station 28 has its angular orientation determined and is then rotated such that one of the first 15a, second 15b, and third 15c reference markers is disposed at a pre-determined angular orientation with respect to the angular reference frame substantially concurrently with a three-dimensional landmark being formed on another marked compact disc 22a on the landmark forming station 38.

The disc unloading station 42 comprises a spindle support base 43 mounted to the main table 2 by depending legs 43a. A sliding unloading tray 44 is retained on the spindle support base 43 in removable and replaceable relation. A lock member 45 engages a co-operating bore hole in the spindle support base 43, which lock member 45 is manually operable by means of a handle member 45a. A spindle 44a projects upwardly from the sliding unloading tray 44 through a platten 45c and a spacer 45b. The finished compact discs 42a are received around the spindle 44a in supported relation on the spacer 45b. The sliding unloading tray 44, the platten 45c, the spacer 45b, and the spindle 45b together form a compact disc carrier that is used to unload finished compact discs 42a from the disc unloading station 42. Two stop members 47 are securely mounted on the spindle support base 43 to preclude the sliding unloading tray 44 from being inadvertently slid off the outer end of the spindle support base 43.

In use, in order for an operator to load marked compact discs 22a into the compact disc carrier at the disc loading station 22, the handle 25a is lifted to release the locking mechanism 25, and the sliding loading tray 24 is slid outwardly from a position as shown in the Figures, to a position whereat the sliding loading tray 24 is removed from the table 2. A plurality of marked compact discs 22a, each preferably having data, printed artwork, necessarily including at least a first reference marker 15a, and preferably also having a second reference marker 15b, and a third reference marker 15c, are loaded by an operator onto the spindle 24a of the compact disc carrier. The sliding loading tray 24 is then replaced and slid to a position as shown in the Figures. The stack lifter mechanism 26 lifts the spindle 24a of discs to the propert height for the pick and place arm assembly 46.

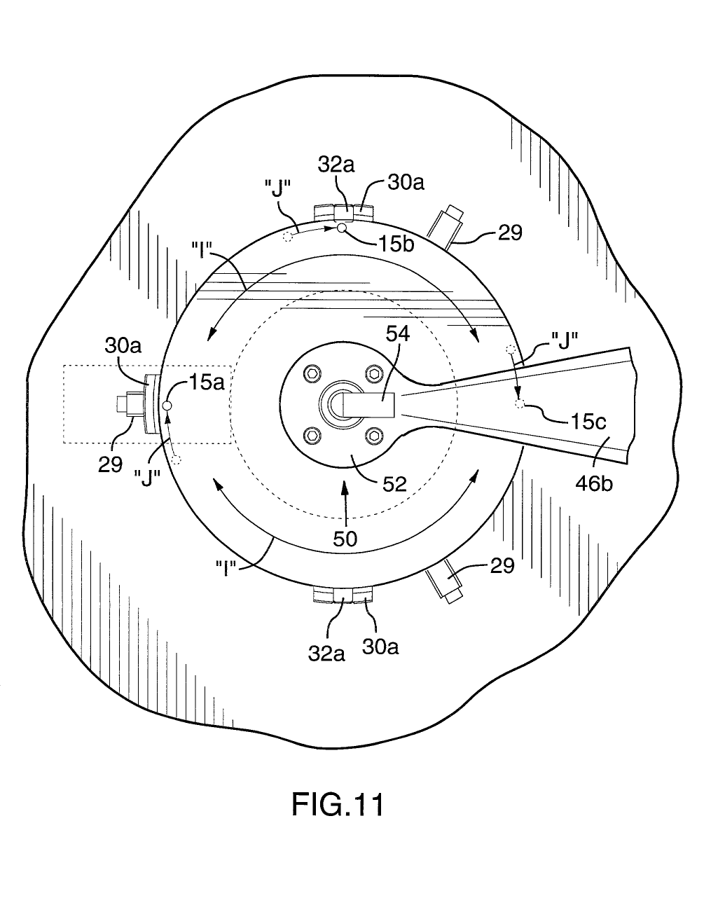

The first arm portion 46a of the pick and place arm assembly 46 then picks up the uppermost of the marked compact discs 22a from the spindle 24a (using the vacuum cups 48) at the disc loading station 22 and moves it to the disc orienting station 28, as indicated by arrow “K” in FIG. 15. At the disc orienting station 28, the marked compact disc 22a is placed on the orientation platter 30 of the disc orienting station 28, as indicated by arrow “A” in FIG. 10A. The hydraulic cylinders 33b are then actuated so as to cause the collar member 33 to travel vertically downwardly along the spindle 33a, as indicated by arrows “B” in FIG. 10B. The lower portions 32c of the pivotally mounted fingers 32a follow the collar member 33, as indicated by arrows “C” in FIG. 10B, as caused by gravity and by biasing springs 33c. Accordingly, the clamping portions 32b on the pivotally mounted fingers 32a move inwardly towards the outer edge of the marked compact disc 22a, as indicated by arrows “D” in FIG. 10B and FIG. 10D, to thereby clamp the marked compact disc 22a in place. As can be best seen in FIG. 11, the orientation platter 30 is rotated in either direction under control of the visual computer (not shown) acting through, as necessary, is indicated by double ended arrows “I”, thus moving the first 15a, second 15b, and third 15c reference markers, as indicated by arrow “J”, such the second reference marker 15b is aligned as shown, directly outwardly from the end of the first arm portion 46a of the pick and place arm 46. In this manner, the second reference marker 15b will be placed correctly for the drilling of the small CNC reference hole 43h through it at the drilling station 38.

In order to determine the angular orientation of the marked compact disc 22a, the means for automatic visual disc inspection 34 is used. The digital camera 36, is mounted over the orientation platter 30, takes a digital image of the disc thereon and sends this image to the vision computer 37 for processing. The vision computer 37 determines the actual orientation of the disc using the first reference marker 15a, the second reference marker 15b, and the third reference marker 15c. Actually, not all three reference markers are necessary, but are preferably included for the sake of redundancy. Orientation information is then calculated by the visual computer (not shown) and appropriate signals are sent to the electric server motor 31 which drives the spindle 33a and the orientation platter 30 to, in turn, rotate the disc to the corrected reference orientation stored in the computer.

The marked compact disc 22a is then unclamped from the orientation platter 30 by means of the hydraulic cylinders 33b being actuated so as to cause the collar member 33 to travel vertically upwardly along the spindle 33a, as indicated by arrows “E” in FIG. 10C. The lower portions 32c of the pivotally mounted fingers 32a follow the collar member 33, as indicated by arrows “F” in FIG. 10C, against the biasing springs 33c. Accordingly, the clamping portions 32b on the pivotally mounted fingers 32a move outwardly away from the outer edge of the marked compact disc 22a, as indicated by arrows “G” in FIG. 10C and FIG. 10E, to thereby release the marked compact disc 22a in place.

The second arm portion 46b of the pick and place arm assembly 46 then picks up the now properly oriented marked compact disc 22a (using the vacuum cup 48) from the orientation platter 30, as indicated by arrows “H” in FIG. 10C and FIG. 10E, and moves the marked compact disc 22a from the disc orienting station 28 to the landmark forming station 38, as indicated by arrow “L” in FIG. 15.

At the landmark forming station 38, the drill bit 40a that extends downwardly from the drill head 40 drills the small CNC reference hole 43h in a set position in each marked compact disc 22a, at the second reference marker 15b. It will be appreciated that, on account of the re-orientation that has taken place on the orientation platter 30, the CNC reference hole 43h will also be precisely located with respect to the graphical pattern 13 on the marked compact disc 22a.

The third arm portion 46c of the pick and place arm assembly 46 then picks up the finished compact disc 43a (using the vacuum cup 48) and moves it to the disc unloading station 42, as indicated by arrow “M” in FIG. 15, where it is released onto the unload spindle 44. When the unload spindle 44 is full, the apparatus 20 of the present invention is temporarily stopped, and the discs are unloaded to, for example, a CNC router machine having an orientation pin sized and positioned to be inserted through the CNC reference hole 43h in the finished compact discs 42a. If the pin is sufficiently long, a plurality of the finished compact discs can be simultaneously stacked at the starting position of the CNC router machine for automatic processing of said stack. This allows discs with such reference holes 43h to be quickly and readily indexed to a starting position on the CNC router machine without the need for visual alignment by the router operator, for subsequent cutting to the final shape desired.

Thus, the process and apparatus of the present invention can be used in conjunction with conventional optical discs 10 and CNC router machines (not shown) with only minor modifications thereto. Upon loading a spindle of marked compact discs 22a that are not yet cut to shape at the disc loading station of the present invention and actuating the machine 20, each disc is thereafter moved through the successive stations of the apparatus and drilled with a small CNC reference hole 43h, before being released at the unload spindle. When the unload spindle 74 is full, the apparatus 20 of the present invention is stopped, and the discs are unloaded to a CNC router machine modified by the mere addition of an alignment pin to accept the discs in aligned relation, using the small CNC reference hole 43h drilled therein, prior to cutting them into the desired custom shapes. In this manner, the manufacturer is saved considerable expense and the potential risk of error from having to visually align each disc manually. Moreover, the three-dimensional reference hole 43h can be used to index the finished compact discs 43a for other processing, including without limitation, oriented labelling and packaging.

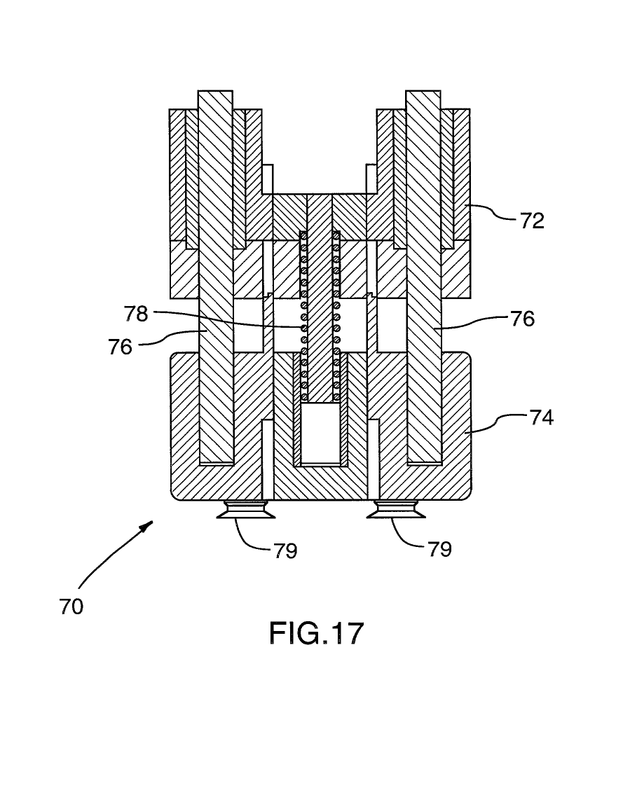

Reference will now be made to FIG. 17 which shows an alternative embodiment vacuum pickup head, indicated by the general reference numeral 70, used on the pick and place arm 46 (not shown in FIG. 17). The alternative embodiment vacuum pickup head 70 has an upper base assembly 72 that is directly mounted onto the pick and place arm 46, and a lower movable assembly 74 that is mounted in vertically slidable relation on the upper base assembly 72 by means of dowel pins 76. The lower movable assembly 74 is spring biased downwardly by coil spring 78 to preclude hard impact of the lower movable assembly 74 onto the upper base assembly 72. The purpose of the alternative embodiment vacuum pickup head 70 is to provide vertical compliance, to thereby increase the dwell time of the suction cups 79 on a compact disc, when the vacuum pickup head 70 is picking up a marked compact disc 22a from one of the stations 22, 28, and 38 or is placing a compact disc on one of the stations 28, 38, and 42. It has been found that the alternative embodiment vacuum pickup head 70 increases the dwell time from about 60 milliseconds (for the pickup head 50) to about 120 milliseconds.

Optionally, in alternate embodiments of the invention, the shaped compact disc orientation process and apparatus may be equipped with automatic loading and unloading mechanisms (not shown), eliminating the need for a worker to manually load or unload the discs from the respective spindles.

As well, although the present invention has been described for use with optical compact discs printed with three reference markers thereon, it will be evident that the present invention is not so limited. That is, the teachings of the present invention could also be applied in the absence of three reference markers so printed. In such an embodiment, an alternate reference means capable of automatic digital pattern analysis by a visual computer might be employed.

Other modifications and alterations may be used in the design and manufacture of the shaped compact disc orientation and drilling process and apparatus according to the present invention without departing from the spirit and scope of the invention.

I claim:

1. An apparatus for producing a three-dimensional landmark on compact discs for subsequent use or processing of said compact discs relative to said three-dimensional landmark, said apparatus comprising:
a disc orienting station for orienting marked compact discs each having at least one reference marker marked thereon, and including means for automatically determining the angular orientation, with respect to an angular reference frame, of said at least one reference marker on said marked compact disc disposed at said disc orienting station, and means for automatically rotating said marked compact disc disposed at said disc orienting station about a central axis of said compact disc such that said at least one reference marker is disposed at a pre-determined angular orientation with respect to said angular reference frame;
a landmark forming station including means for forming said three-dimensional landmark on the marked compact disc disposed at said landmark forming station, in a location having a known angular displacement about said central axis of said compact disc with respect to said at least one reference marker;
disc transport means comprising means for transporting said compact discs in seriatim from said disc orienting station in said predetermined angular orientation to said landmark forming station.

2. An apparatus for producing a three-dimensional landmark on compact discs for subsequent cutting of said compact discs, relative to said three-dimensional landmark, into non-standard shaped compact discs, said apparatus comprising:
a disc orienting station for orienting marked compact discs having at least one reference marker marked thereon, and including means for automatically determining the angular orientation, with respect to an angular reference frame, of said at least one reference marker on the marked compact disc disposed at said disc orienting station, and means for automatically rotating said marked compact disc disposed at said disc orienting station about a central axis of said compact disc such that said at least one reference marker is disposed at a pre-determined angular orientation with respect to said angular reference frame;
a landmark forming station including means for forming said three-dimensional landmark on the marked compact disc disposed at said landmark forming station, in a location having a known angular displacement about said central axis of said compact disc with respect to said at least one reference marker;
disc transport means comprising means for transporting said compact discs in seriatim from said disc orienting station to said landmark forming station.

3. The apparatus of claim 2, further comprising a disc unloading station whereat compact discs are unloaded from said apparatus, and said disc transport means further comprises means for transporting said compact discs in seriatim from said landmark forming station to said disc unloading station in said predetermined angular orientation.

4. The apparatus of claim 3, further comprising a disc loading station whereat marked compact discs having at least one reference marker thereon, are loaded into said apparatus, and said disc transport means further comprises means for transporting said compact discs in seriatim from said disc loading station to said disc orienting station.

5. The apparatus of claim 4, wherein said compact discs further comprise a graphical pattern thereon.

6. The apparatus of claim 5, wherein said means for forming said three-dimensional landmark comprises a drill mechanism and said three-dimensional landmark comprises a drill hole.

7. The apparatus of claim 6, wherein said first predetermined location is disposed exteriorly to said graphical pattern.

8. The apparatus of claim 7, wherein said at least one reference marker comprises first and second reference markers.

9. The apparatus of claim 8, wherein said at least one reference marker comprises first, second and third reference markers.

10. The apparatus of claim 9, wherein said reference markers are located adjacent the perimeter edge of each of said marked compact discs.

11. The apparatus of claim 10, wherein said means for automatically determining the angular orientation with respect to an angular reference frame of said at least one reference marker comprises a digital camera mounted at said disc orienting station and a computer operatively connected to said digital camera.

12. The apparatus of claim 11, wherein said means for automatically rotating the marked compact disc disposed at said disc orienting station comprises a rotatable orientation platter.

13. The apparatus of claim 12, further comprising four peripheral guides operatively mounted adjacent a rotatable orientation platter for guiding the marked compact discs onto the rotatable orientation platter.

14. The apparatus of claim 13, wherein said disc orienting station further comprises a clamping mechanism for clamping in place the marked compact disc disposed on the rotatable orientation platter.

15. The apparatus of claim 14, wherein said clamping mechanism comprises a pair of opposed finger members each pivotally mounted on a respective one of said four peripheral guides, with each finger having a clamping portion for clamping said marked compact discs in place on said rotatable orientation platter, as aforesaid.

16. The apparatus of claim 15, wherein said disc orienting station further comprises at least one proximity sensor for detecting the presence one of said compact discs on the rotatable orientation platter.

17. The apparatus of claim 16, wherein said disc transport means comprises a pick and place arm assembly.

18. The apparatus of claim 17, wherein said disc loading station, said disc orienting station, said landmark forming station, and said disc unloading station are circumferentially arranged with respect to each other, said pick and place arm assembly is operatively mounted on said apparatus centrally between said stations, for rotary motion about a substantially vertical axis.

19. The apparatus of claim 18, wherein said pick and place arm assembly is pivotally mounted on said apparatus.

20. The apparatus of claim 19, wherein said pick and place arm assembly is pivotally mounted on said apparatus for bi-directional pivotal movement about said vertical axis.

21. The apparatus of claim 20, wherein said pick and place arm assembly comprises a first arm portion, a second arm portion, and third arm portion.

22. The apparatus of claim 21, wherein said known angular displacement about said central axis of said compact disc with respect to said at least one reference marker is zero degrees.

23. A method of producing a three-dimensional landmark on a plurality of compact discs for subsequent use or processing of said compact discs relative to said three-dimensional landmark, said method comprising the steps of:
(A) introducing at least one reference marker onto each of said compact discs at a first predetermined location, to thereby produce marked compact discs;
(B) automatically determining the angular orientation with respect to an angular reference frame of said at least one reference marker on each marked compact disc;
(C) automatically rotating each marked compact disc about a central axis of said compact disc such that said at least one reference marker is disposed at a pre-determined angular orientation with respect to an angular reference frame;
(D) forming said three-dimensional landmark on each marked compact disc in a location having a known angular displacement about said central axis of said compact disc with respect to said at least one reference marker.

24. A method of producing a three-dimensional landmark on plurality of compact discs for subsequent cutting of said compact discs relative to said three-dimensional landmark, into non-standard shaped compact discs, said method comprising the steps of:
(A) introducing at least one reference marker onto each of said compact discs at a first predetermined location, to thereby produce marked compact discs;
(B) automatically determining the angular orientation with respect to an angular reference frame of said at least one reference marker on each marked compact disc;
(C) automatically rotating each marked compact disc about a central axis of said compact discs such that said at least one reference marker is disposed at a pre-determined angular orientation with respect to an angular reference frame;
(D) forming said three-dimensional landmark on each marked compact disc in a location having a known angular displacement about said central axis of said compact disc with respect to said at least one reference marker.

25. The method of claim 24, further comprising the step of introducing a graphical pattern to each marked compact disc.

26. The method of claim 25, wherein in step (A), said first predetermined location is disposed exteriorly to said graphical pattern.

27. The method of claim 26, wherein step (D) comprises drilling a drill hole through each marked compact disc in a location having a known angular displacement about said central axis of said compact disc with respect to said at least one reference marker.

28. The method of claim 27, wherein step (A) comprises printing said at least one reference marker onto each of said compact discs at a first predetermined location.

29. The method of claim 28, wherein step (A) comprises printing first and second reference markers onto each of said compact discs at first and second predetermined locations, respectively.

30. The method of claim 29, wherein step (A) comprises printing first, second and third reference markers onto each of said compact discs at first, second and third predetermined locations, respectively.

31. The method of claim 30, wherein in step (A), said first predetermined location is disposed adjacent the perimeter edge of said compact discs.

32. The method of claim 31, wherein in step (D), said known angular displacement of said drill hole with respect to said at least one reference marker is substantially zero degrees.

33. The method of claim 24, wherein step (B) and step (C) are performed at a disc orienting station and step (D) is performed at a landmark forming station, and said disc orienting station and said landmark forming station are separate and distinct one from the other, and further comprising the step of transporting said compact discs in seriatim from said disc orienting station to said landmark forming station.

34. The method of claim 33, further comprising, prior to step (B), the step of loading of a plurality of compact discs into a loading station and transporting said compact discs in seriatim from said loading station to said disc orienting station.

35. The method of claim 34, further comprising, subsequent to step (D), the step of transporting said plurality of compact discs in seriatim from said landmark forming station to a disc unloading station and thereafter unloading said compact discs from said disc unloading station.

36. The method of claim 35, wherein step (B) and step (C) are performed on one marked compact disc substantially concurrently with step (D) being performed on another marked compact disc.
